(19) United States
(12) Patent Application Publication
(10) Pub. No.: US 2002/0092430 A1
(43) Pub. Date: Jul. 18, 2002

(54) Device for draining liquid from a can

(76) Inventor: Marianne Dempsey, Kennett Square, PA (US)

Correspondence Address: CONNOLLY BOVE LODGE & HUTZ, LLP, 1220 N MARKET STREET, P O BOX 2207, WILMINGTON, DE, 19899

(21) Appl. No.: 09/758,505

(22) Filed: Jan. 12, 2001

(51) Int. Cl. B30B 7/00

(52) U.S. Cl. 100/234

(57) ABSTRACT

A device for draining liquid from a can includes a pair of arms pivotally mounted to each other with each arm having a handle end and an operating end remote from the handle end. One of the operating ends includes can restraining structure for receiving a can. The other of the operating ends includes a perforated strainer for moving into the can after a lid has been removed so that liquid may be drained from the can.

### BACKGROUND OF THE INVENTION

Various types of products, such as food products, are packaged in cans, such as metal cans, wherein the can also contains some form of liquid, such as water or oil, with the food product. A typical example of such a food product is in the packaging of tunafish. Other types of food products are also packaged in cans containing packaging liquid. When it is desired to use the food product, the user detaches the lid such as by the use of a can opener or by pulling the lid away from the can where a detachable lid is provided. The can is then inverted so that the liquid is able to drain from the can. Frequently the user might retain the lid at least partially blocking the open end of the can to prevent the food product, itself, from falling out of the can while the liquid is draining.

Various attempts have been made to provide devices for draining liquid from a can. Examples of such devices include U.S. Pat. No. Des. 311,116 and Des. 343,995 as well as U.S. Pat. Nos. 3,995,544; 4,860,647; 5,501,144; and 5,706,721. It would be desirable if a device could be provided which is easy to operate and yet effective in draining the liquid while retaining the contents of the can within the can.

### SUMMARY OF THE INVENTION

On object of this invention is to provide a device for draining liquid, from a can which meets the above needs.

A further object of this invention is to provide such a device which is convenient to operate and effective in its liquid draining action as well as being safe.

In accordance with this invention a device for draining liquid from a can includes a pair of elongated arms. Each arm has a handle end and an operating end remote from the handle end. The arms are pivotally mounted together in a scissors like fashion so that when the handle ends are squeezed toward each other the operating ends also move toward each other. One of the operating ends includes can restraining structure for receiving and holding the base of a can during the squeezing of the handles. The other of the operating ends includes a plate-like strainer which is dimensioned to slidably fit into the interior of the can after the lid has been removed. The strainer is perforated so as to drain liquid from the can and through the perforations as the strainer is pressed against the contents of the can.

In a preferred practice of the invention the one operating end is in the form of a receptacle wherein a peripheral lip extends around a base to receive the can in the receptacle. The strainer is pivotally mounted to its operating end so that it is capable of adjusting its orientation during the squeezing action to assure proper sliding movement of the strainer into the can.

In a preferred practice of the invention the strainer includes at least one magnet so that the strainer may also function to contact and hold the lid after the lid has been detached from the can. Thus, the strainer would be moved into contact with the lid by squeezing the handles toward each other. Once contact has been achieved, the handles would be separated to lift the lid away from the can because of the magnetic attraction between the metal lid and the magnet. The lid can then be safely removed and discarded. After removing the lid the handles would be squeezed toward each other and the device would be inverted to accomplish the draining operation.

The strainer preferably includes a plurality of concentric grooves on its contents contacting surface with the perforations located in the grooves. The grooves thus provide areas of flow for the liquid communicating with the perforations to facilitate the draining action.

### THE DRAWINGS

FIG. 1 is a side elevational view partly in section of a device for draining liquid from a can in accordance with this invention;

FIG. 2 is a top plan view of the device shown in FIG. 1;

FIG. 3 is a front elevational view of the device shown in FIGS. 1-2;

FIG. 4 is a rear elevational view of the device shown in FIGS. 1-3;

FIG. 5 is a cross-sectional view of a portion of the device shown in FIGS. 1-4;

FIG. 6 is a fragmental bottom plan view of the strainer element in the device of FIGS. 1-4;

FIG. 7 is a side elevational view showing the lid removal operation of the device of FIGS. 1-4; and

FIG. 8 is a view similar to FIG. 7 showing the device inverted for the draining of the liquid.

### DETAILED DESCRIPTION

The present invention relates to a device for draining liquid from a can in such a manner that the main contents of the can remain within the can while the liquid is permitted to be drained. The contents may take various forms, such as being a food product. A particular utility of the invention is with tunafish cans. It is to be understood, however, that other types of contents including other types of food products may also be used such as salmon, shrimp, oysters,, clams, vegetables (such as kidney beans) and fruits where the liquid should be drained from the contents for cooking purposes.

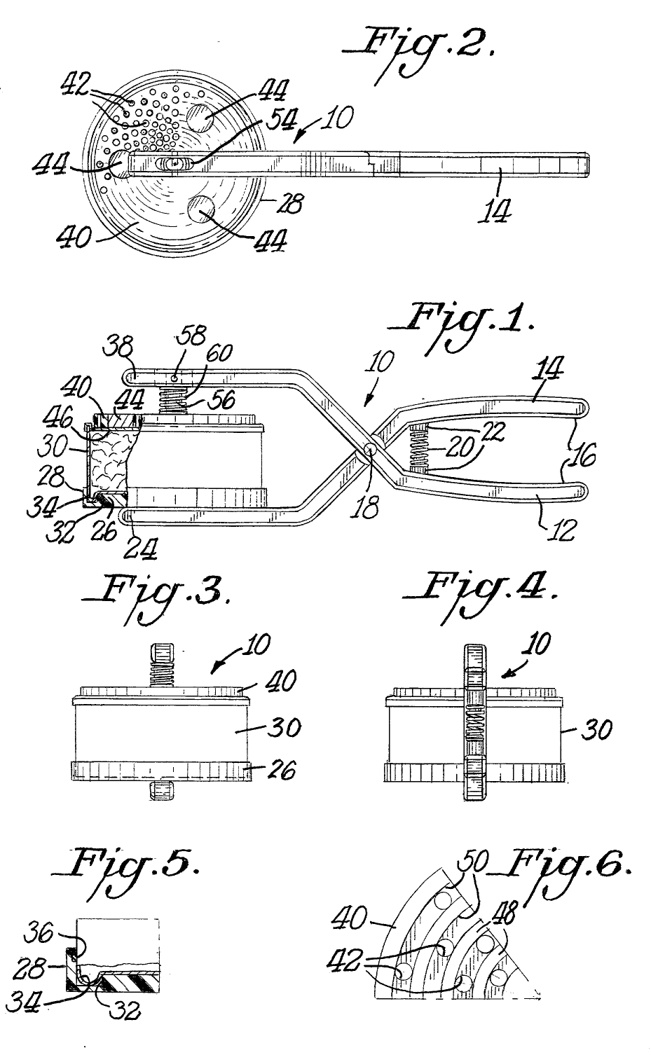

FIGS. 1-4 illustrate, in general, the structure of a device 10 in accordance with the preferred practice of this invention. As shown therein, device 10 includes a pair of elongated arms 12,14. Each arm 12,14 has a handle end 16,16 and an operating end 24,38 remote from the handle ends. The arms are pivoted together in any suitable manner such as by a pivot pin 18. In order to maintain a uniform thickness each arm is notched about halfway into its thickness at the pivot pin so that the arms generally interlock at that location. In the preferred practice of the invention a coil spring 20 is mounted on two posts 22,22 to bias the device 10 to its open position. This arrangement is generally similar to a scissors type arrangement whereby the squeezing of the arms toward each other causes the remote operating ends to also be squeezed toward each other. Similarly, spreading of the arms apart from each other causes the operating ends to move apart from each other as shown, for example, in FIGS. 7-8.

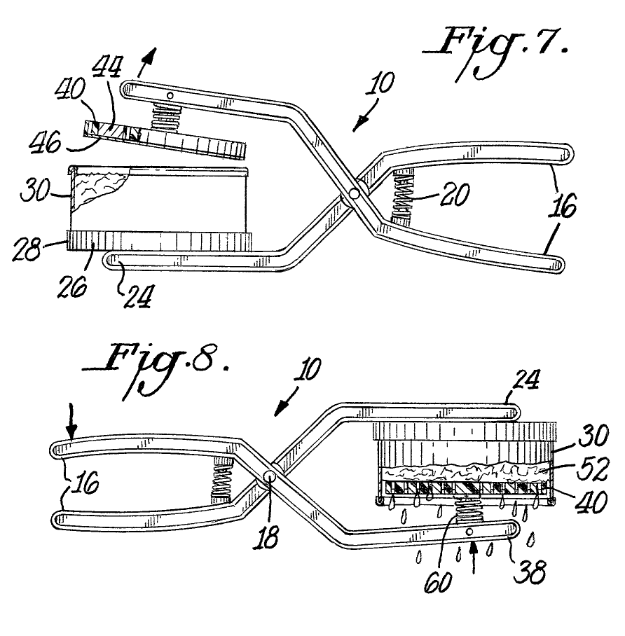

Arm 14 is provided at its operating end 24 with can restraining structure. In the preferred practice of this invention illustrated herein the can restraining structure is in the form of a base or support 26 of plate-like form. An upstanding peripheral lip 28 extends completely around support 26 to form a shallow receptacle into which the can 30 would be placed. As shown in FIGS. 1 and 5 a groove 32 may be provided adjacent to the lip 28 to receive the lip 34 of the can. If desired, the inner wall of lip 28 may include an O-ring 36 for gripping the side wall of the can. These various provisions of features such as the O-ring 36, the groove 32 and the upstanding lip 28 assure maintaining the can in place.

While the receptacle type structure for maintaining the can in place is the preferred practice of the invention, it is to be understood that other types of structure may also be used. For example, the support 26 may have only partial upstanding lip segments which preferably include at least two and more preferably at least three lip segments to prevent sidewards movement of the can 30. Another variation would be to have these lip segments laterally movable so as to accommodate different diameter cans. Alternatively, the lip or lip segments may be stationarily mounted to the base but may include laterally movable projections to accommodate smaller cans which are of a size smaller than the diameter formed by the upstanding lip or lip segments.

The operating end 38 of arm 12 is provided with a strainer 40. As shown therein the strainer 40 is basically a circular disk having a plurality of perforations 42 extending completely through the strainer to permit liquid to flow through the strainer. In the preferred practice of the invention strainer 40 includes at least one and preferably a plurality of magnets 44. In operation the lid 46 of the can 30 could be detached from the can in any conventional manner such as by a can opener or by a pulling action where a pull type lid is provided. With reference to FIG. 7 the can 30 would be mounted to the receptacle support 26 within the lip 28. The handles 16,16 would be moved toward each other causing the strainer 40 to move toward and into contact with the lid 46. Lid 46 would be magnetically held to strainer 40 and, as shown in FIG. 7, the handles 16,16 could be permitted to move away from each other thereby raising the strainer 40 and lid 46 away from can 30. With the lid 46 thereby exposed, it is possible to safely remove the lid 46 from strainer 40 and discard the lid.

As shown in FIG. 6 the contents contacting surface 48 of strainer 40 is provided with a plurality of grooves 50 which are preferably concentric with each other. The perforations or holes 42 are located within these grooves 50. The grooves 50 provide channels for the liquid to flow and then be dispensed through the perforations 42.

FIG. 8 illustrates the manner of draining the liquid from the can. As shown therein the can would be mounted to the operating end 24 of arm 14, as previously described with respect to FIG. 7. After the lid has been removed and discarded the handles 16 would be squeezed toward each other until the strainer 40 begins to enter the can 30. Device 10 would then be inverted to the position shown in FIG. 8 so that the strainer is now on the bottom. As the handles 16,16 continue to be squeezed toward each other the strainer slides into the can 30 permitting the liquid to drain through the holes 42. The draining operation may be enhanced by squeezing the strainer 40 against the contents 52 if such squeezing will not damage the contents 52.

In order to maintain the strainer 40 against the contents 52 during the squeezing action, a pivot type connection is made between strainer 40 and operating end 38. For example, as illustrated in FIGS. 1 and 2 the operating end 38 of arm 12 has an elongated slot 54. A post 56 is mounted to operating arm 38 by a pin 58 extending through the operating end 38 and post 56 at the slot 54. Pin 58 thereby functions as a pivot pin permitting the post 56 to rotate with the degree of rotation being limited only by the dimensions of the operating arm 38 and slot 54. If desired, a coil spring 60 could be mounted between operating end 38 and strainer 40.

Although FIGS. 1-2 illustrate the strainer to be pivotally mounted in a back and forth direction to operating end 38, other pivotal structure may be utilized such as a universal or ball joint which would permit complete 360° rotation of the strainer 40.

Various materials may be used for device 10. For example, the entire device could be made of a plastic material or only parts thereof made of plastic with the other parts made of other materials such as metal and preferably stainless steel. If desired, the metal could have a plastic coating particularly on the contents contacting face 48 of strainer 40. This would assure that no metal touches the contents 52 of the can 30. The use of a plastic part or plastic coating would also ensure that the plastic coating on the inside of the can is not scratched or scraped away thereby exposing the metal from the can to the contents 52.

As can be appreciated device 10 avoids the need for the user's fingers squeezing the liquid from a can because of the provision of strainer 40. The strainer 40 also avoids the common practice of a user maintaining the lid at least partially covering the can to prevent the contents from falling out of the can during the draining operation. In such prior practices where the lid is used there is a danger of the sharp edge of the lid cutting the user. The provision of magnets 44 to automatically lift the lid 46 from the can 30 also is advantageous in that it automatically disposes the lid to a position where it can be safely removed from the strainer and discarded.

What is claimed is:

1. A device for draining liquid from a can comprising a pair of arms, each.of said arms having a handle end and an operating end remote from said handle end, a pivot member pivotally mounting said arms together whereby the squeezing of said handle ends toward each other causes said operating ends to move toward each other, one of said operating ends having can restraining structure for receiving the base of a can and mounting the can to said one operating end during the squeezing of said handle ends, the other of said operating ends having a strainer thereon for slidably fitting into the interior of the can, and said strainer being perforated to drain liquid from the can through the perforations when said strainer is pressed against the contents of the can.

2. The device of claim 1 including magnetic structure on said strainer for facilitating the removal of a metal lid from the can.

3. The device of claim 2 wherein said restraining structure comprises a peripheral lip mounted to a planar support whereby the base of the can may be placed on said support, and said peripheral lip restrains lateral movement of the can.

4. The device of claim 3 wherein said peripheral lip extends completely around said support to create a receptacle for holding the can.

5. The device of claim 4 wherein said strainer is plate-like and has a contents contacting surface, a plurality of grooves being formed in said contacting surface, and said perforations being in said grooves.

6. The device of claim 5 wherein said grooves are concentrically arranged with respect to each other.

7. The device of claim 6 wherein said strainer is pivotally mounted to its said operating end to permit adjustment of the orientation of said strainer.

8. The device of claim 7 wherein said strainer is pivotally mounted for a back and forth reciprocal movement.

9. The device of claim 8 wherein a return spring is mounted between said handle ends to bias said device into an open position.

10. The device of claim 9 wherein said support includes a groove adjacent to its outer periphery to receive the edge of the can.

11. The device of claim 10 wherein a compressible O-ring is provided on the inner surface of said lip to contact the can.

12. The device of claim 1 wherein said restraining structure comprises a peripheral lip mounted to a planar support whereby the base of the can may be placed on said support, and said peripheral lip restrains lateral movement of the can.

13. The device of claim 12 wherein said peripheral lip extends completely around said support to create a receptacle for holding the can.

14. The device of claim 12 wherein said support includes a groove adjacent to its outer periphery to receive the edge of the can.

15. The device of claim 12 wherein a compressible O-ring is provided on the inner surface of said lip to contact the can.

16. The device of claim 1 wherein said strainer is plate-like and has a contents contacting surface a plurality of grooves being formed in said contacting surface, and said perforations being in said grooves.

17. The device of claim 16 wherein said grooves are concentrically arranged with respect to each other.

18. The device of claim 1 wherein said strainer is pivotally mounted to its said operating end to permit adjustment of the orientation of said strainer.

19. The device of claim 2 wherein said strainer has a contents contacting surface, a plurality of grooves being formed in said contacting surface, and said perforations being in said grooves.

20. The device of claim 2 wherein said strainer is pivotally mounted to its said operating end to permit adjustment of the orientation of said strainer.
